(19) United States
(12) Patent Application Publication
(10) Pub. No.: US 2026/0218543 A1
(43) Pub. Date: Jul. 30, 2026

(54) LOCKING POLE LIGHT HANDHOLE COVER

(71) Applicant: James Joseph Craig, Moriarty, NM (US)

(72) Inventor: James Joseph Craig, Moriarty, NM (US)

(21) Appl. No.: 19/335,127

(22) Filed: Sep. 22, 2025

Related U.S. Application Data
(60) Provisional application No. 63/750,724, filed on Jan. 28, 2025.

(51) Int. Cl. E05B 65/00

(52) U.S. Cl. CPC E05B 65/0064

(57) ABSTRACT

A locking pole light handhole cover assembly may comprise a pole light handhole cover comprising a flat plate with a center hole. A cover offset bracket may comprise a center hole with female threads. The cover offset bracket may be positioned inside a pole conduit. A threaded rod lock may comprise a threaded rod with male threads and a key-operated mechanism. The threaded rod may pass through the center holes of the pole light handhole cover and the cover offset bracket. The male threads of the threaded rod may engage with the female threads of the cover offset bracket to secure the assembly through internal anchoring within the pole conduit. The key-operated mechanism may comprise a key that may be inserted into the threaded rod lock to control rotational movement of the threaded rod. The cover offset bracket may be configured to contact an interior wall of the pole conduit when the threaded rod may be advanced.

### CROSS-REFERENCE TO RELATED APPLICATIONS

This application claims the benefit of U.S. Provisional Ser. No. 63/750,724, filed Jan. 28, 2025, which is incorporated herein by reference in its entirety.

### TECHNICAL FIELD

This disclosure relates generally to security devices for electrical infrastructure. More particularly, this disclosure relates to locking mechanisms for handhole covers used in lighting pole systems to prevent unauthorized access to electrical wiring.

### BACKGROUND

The following background information may present examples of specific aspects of the prior art (e.g., without limitation, approaches, facts, or common wisdom) that, while expected to be helpful to further educate the reader as to additional aspects of the prior art, may not constitute admissions of any relevance to the presently disclosed subject matter. Similarly, any discussion of problems in the prior art or particular shortcomings of the prior art may not constitute admissions of relevance to the presently disclosed subject matter. Lighting poles used in outdoor installations commonly comprise conduit-shaped structures containing electrical wires that extend from the base to lighting fixtures positioned at the top of the pole. These installations typically include handhole access points positioned approximately one foot above the pole base, where electrical wires may be exposed to facilitate maintenance and electrical work. The handhole openings may be raised away from the pole surface to accommodate flat plate covers, and the openings may have square or oblong configurations.

Conventional pole light handhole covers may lack locking mechanisms, potentially leaving electrical wires inside lighting poles vulnerable to theft. Copper wiring and other electrical components may be valuable targets for unauthorized removal, particularly in unsecured outdoor installations. This vulnerability may result in costly repairs, service interruptions, and safety hazards. Various approaches have been attempted to address security concerns in electrical infrastructure, but these approaches may have limitations in terms of effectiveness, cost, or ease of authorized access. Some security measures may be easily circumvented by unauthorized persons, while others may impede legitimate maintenance activities.

Accordingly, there may be a need for improved security systems that may provide effective protection against unauthorized access while maintaining convenient access for authorized maintenance personnel.

### BRIEF OVERVIEW

The following presents a simplified overview of some aspects of the disclosed subject matter in order to provide a basic understanding of such aspects. This overview may not be an extensive overview of all contemplated aspects, and may neither identify key or critical elements of all aspects nor delineate the scope of any or all aspects of this disclosure. Its sole purpose may be to present some concepts of one or more aspects of the disclosed subject matter in a simplified form as a prelude to the more detailed description that may be presented later. The present disclosure describes systems, devices, and methods that may provide secure protection for electrical wires within lighting pole conduits through the use of a locking pole light handhole cover assembly. The assembly may incorporate a threaded rod locking mechanism that may secure the cover assembly from inside the pole conduit, potentially preventing unauthorized removal while allowing authorized access through key-operated control.

In some aspects, a locking pole light handhole cover assembly may comprise a pole light handhole cover, a cover offset bracket, and a threaded rod lock. The pole light handhole cover may comprise a flat plate configuration with a center hole for threaded rod passage. The cover offset bracket may comprise a center hole with female threads and may be positioned inside a pole conduit. The threaded rod lock may comprise a threaded rod that may pass through both the cover and bracket, with a key-operated mechanism that may control rotational movement. The threaded rod lock may advance or retract the threaded rod through key operation, potentially drawing the offset bracket against the interior wall of the pole conduit to create a clamping force that may secure the entire assembly. This internal anchoring system may prevent unauthorized removal of the handhole cover without proper key access.

Various embodiments may include different configurations of the locking mechanism, cover designs, and bracket arrangements. The system may be adaptable to different pole configurations and handhole sizes while maintaining security effectiveness. The disclosed subject matter may find application in outdoor lighting infrastructure, municipal installations, commercial properties, and other environments where protection of electrical components may be desired. The system may provide benefits including theft prevention, reduced maintenance costs, improved safety, and convenient authorized access.

It should be noted that the aspects described herein may be used individually, all together, or in any combination of two or more, as the application may not be limited to any specific combination or arrangement of such aspects.

### BRIEF DESCRIPTION OF THE DRAWINGS

The drawings described below may be for illustration purposes only. The drawings may not necessarily be to scale, with emphasis generally being placed upon illustrating the principles of the disclosed subject matter. In the drawings, like numerals may be used to indicate like parts throughout the various views. Thus, for further understanding of the disclosed subject matter, reference may be made to the following detailed description, read in connection with the drawings in which:

FIG. 1 may be a schematic view of a pole light handhole cover assembly equipped with a threaded rod lock according to some embodiments;

FIG. 2 may be a schematic view of a threaded rod lock according to some embodiments;

FIG. 3 may be a photograph displaying a side view of a pole light handhole cover assembly according to some embodiments; and

FIG. 4 may be a photograph displaying a front view of a pole light handhole cover according to some embodiments.

It should be noted that the figures may be illustrative in nature and may not be drawn to scale. Additionally, elements common between figures may retain the same or similar numbering.

### DETAILED DESCRIPTION

Various detailed embodiments of the present disclosure may be discussed herein in non-limiting ways. It should be noted that the disclosed subject matter may not be limited to any single aspect or embodiment, nor to any combinations and/or permutations of such aspects and/or embodiments. Moreover, each of the aspects of the present disclosure, and/or embodiments thereof, may be employed alone or in combination with one or more of the other aspects and/or embodiments thereof. For the sake of brevity, many of those permutations and combinations may not be discussed separately herein.

As used herein, the singular forms “a,” “an,” and “the” may include plural referents unless the context clearly dictates otherwise. Thus, for example, reference to “a component” may include aspects having two or more such components, unless the context clearly indicates otherwise.

As used herein, the term “substantially” may refer to the complete or nearly complete extent or degree of an action, characteristic, property, state, structure, item, or result. For example, an object that may be “substantially” enclosed would mean that the object may be either completely enclosed or nearly completely enclosed. The exact allowable degree of deviation from absolute completeness may depend on the specific context. However, generally speaking, the nearness of completion may be to have the same overall result as if absolute and total completion were obtained. The use of “substantially” may be equally applicable when used in a negative connotation to refer to the complete or nearly complete lack of an action, characteristic, property, state, structure, item, or result.

As used herein, the term “about” may be used to provide flexibility to a numerical range endpoint by providing that a given value may be “a little above” or “a little below” the endpoint. The degree of flexibility of this term may be dictated by the particular variable and would be within the knowledge of those skilled in the art to determine based on experience and the associated description herein.

As used herein, the terms “optional” or “optionally” may mean that the subsequently described event or circumstance may or may not occur, and that the description may include instances where the event occurs and instances where it does not.

The word “or” as used herein may mean any one member of a particular list and may also include any combination of members of that list. Further, the phrase “one or more” as used herein, depending at least in part upon context, may be used to describe any feature, structure, or characteristic in a singular sense or may be used to describe combinations of features, structures, or characteristics in a plural sense.

As used herein, the phrase “at least one of” preceding a series of items, with the terms “and” or “or” to separate any of the items, may modify the list as a whole, rather than each member of the list (i.e., each item). The phrase “at least one of” may allow a meaning that includes at least one of any one of the items, and/or at least one of any combination of the items, and/or at least one of each of the items. By way of example, the phrases “at least one of A, B, and C” or “at least one of A, B, or C” may each refer to only A, only B, or only C; any combination of A, B, and C; and/or at least one of each of A, B, and C.

The disclosed subject matter may be described herein in terms of functional and/or logical block components, and with reference to symbolic representations of operations, processing tasks, and functions that may be performed by various computing components or devices. Such operations, tasks, and functions may be sometimes referred to as being computer-executed, computerized, software-implemented, or computer-implemented. In practice, one or more processor devices may carry out the described operations, tasks, and functions by manipulating electrical signals representing data bits at memory locations in the system memory, as well as other processing of signals. The memory locations where data bits may be maintained may be physical locations that have particular electrical, magnetic, optical, or organic properties corresponding to the data bits. It should be understood that the various block components shown in the figures may be realized by any number of hardware, software, and/or firmware components configured to perform the specified functions.

It should be noted that some embodiments may include a plurality of processes or steps, which may be performed in various orders, unless expressly and specifically stated otherwise. Furthermore, some processes or steps may be performed in parallel, may be performed serially, or may be performed in a partially overlapping manner. The scope of the present disclosure may encompass all such variations.

All ranges disclosed herein may be inclusive of the endpoints, and the endpoints may be independently combinable with each other. The ranges may be continuous or discontinuous unless otherwise indicated. Each range of values may be supported by experimental results or at least theoretical principles. Each range may characterize any aspect of the embodiments, unless otherwise indicated.

Reference throughout this specification to “one embodiment,” “certain embodiments,” “one or more embodiments” or “an embodiment” may mean that a particular feature, structure, material, or characteristic described in connection with the embodiment may be included in at least one embodiment of the disclosure. Thus, the appearances of the phrases such as “in one or more embodiments,” “in certain embodiments,” “in one embodiment” or “in an embodiment” in various places throughout this specification may not necessarily refer to the same embodiment of the disclosure. Furthermore, the particular features, structures, materials, or characteristics may be combined in any suitable manner in one or more embodiments.

Although the disclosure herein may provide certain preferred embodiments and applications, other embodiments that may be apparent to those of ordinary skill in the art, including embodiments which may not provide all of the features and advantages set forth herein, may also be within the scope of this disclosure. Accordingly, the scope of the present disclosure may be intended to be defined only by reference to the appended claims.

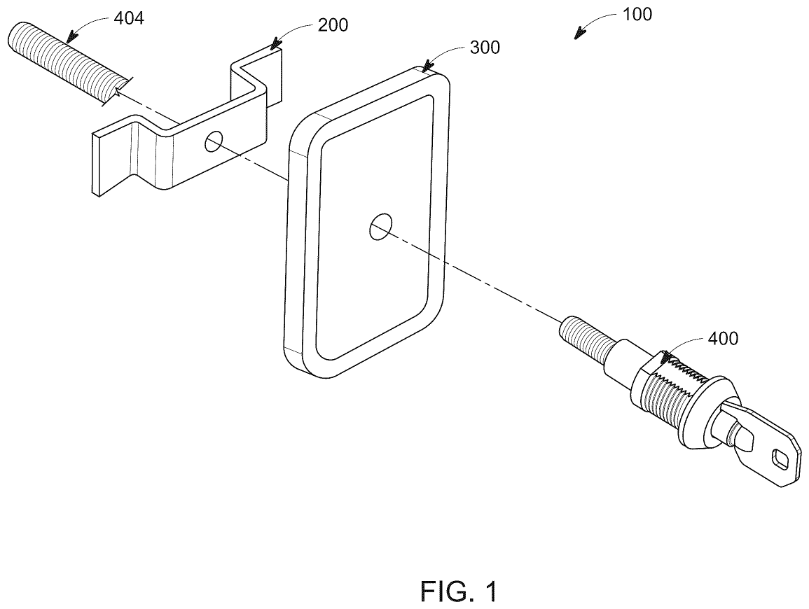

With reference now to the figures, and in particular with reference to FIG. 1, there may be shown a schematic view of a pole light handhole cover assembly 100 that may be equipped with a threaded rod lock 400. The handhole cover assembly 100 may comprise a pole light handhole cover offset bracket 200, a pole light handhole cover 300, and a threaded rod lock 400. The cover offset bracket 200 may comprise a center hole that may have female threads to accept male threads of a threaded rod 404. The threaded rod lock 400 may comprise the threaded rod 404 that may pass through center holes of the handhole cover 300 and the cover offset bracket 200. The female threads of the cover offset bracket 200 may be configured to receive the threaded rod 404. The pole light handhole cover 300 may comprise a flat plate configuration that may be sized to cover square or oblong handhole openings. The handhole cover 300 may include a center hole that may allow passage of the threaded rod 404. The cover 300 may be constructed from durable materials suitable for outdoor environmental conditions. The cover offset bracket 200 may be positioned inside a pole conduit during installation. The bracket 200 may be configured to contact an interior wall of the pole conduit when the threaded rod 404 may be advanced through the threaded engagement. This contact may create a clamping force that may secure the entire assembly 100 to the pole structure.

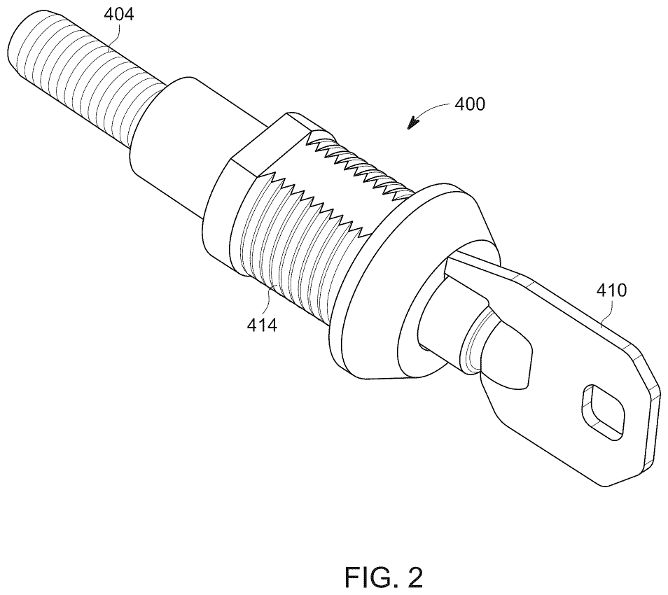

With reference to FIG. 2, there may be shown a schematic view of the threaded rod lock 400. The rod lock 400 may comprise the threaded rod 404, threading 414, and a key 410. When the key 410 may be inserted into the rod lock 400, the key 410 may be configured to turn the rod lock 400 either clockwise or counterclockwise to loosen or tighten the handhole cover assembly 100. The threaded rod 404 may pass through the center holes of the handhole cover 300 and the cover offset bracket 200. The position of the cover offset bracket 200 relative to the threaded rod 404 may be adjustable through rotation of the threaded rod 404. An anchor nut may be configured to be secured onto the threading 414 to attach the handhole cover 300 to the threaded rod lock 400. The key 410 may provide authorized access control for the locking mechanism. The key 410 may be removable from the rod lock 400 after the assembly may be secured or loosened. The key 410 may be configured to engage with internal mechanisms of the rod lock 400 to control rotational movement of the threaded rod 404. The threaded rod lock 400 may comprise a commercial product, such as those available from STOCK LOCKS or equivalent locking mechanisms that may provide similar functionality. The threading 414 may be configured to provide smooth operation and secure engagement with the offset bracket 200.

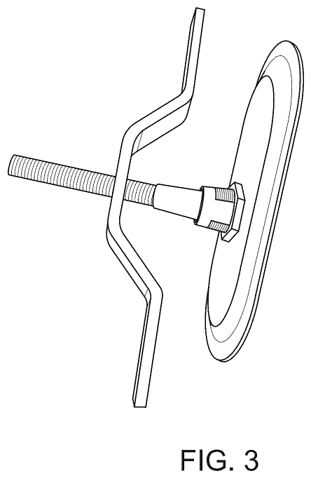

With reference to FIG. 3, there may be shown a side view of the assembled pole light handhole cover assembly 100. When the assembly 100 may be installed on a lighting pole, the offset bracket 200 may be positioned inside the lighting pole conduit. As the threaded rod 404 may be tightened through key operation, the rod 404 may secure the offset bracket 200 to an inside surface of the pole. The assembly 100 may be configured to provide a secure connection that may resist unauthorized removal attempts. The internal positioning of the offset bracket 200 may prevent access to fastening mechanisms from outside the pole structure. The clamping force generated by the threaded rod 404 may distribute load across the interior pole surface through the offset bracket 200.

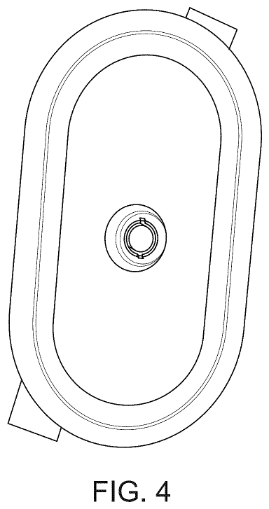

With reference to FIG. 4, there may be shown a front view of the pole light handhole cover 300. The center of the handhole cover 300 may include a locking interface of the threaded rod lock 400, into which the key 410 may be inserted. The key 410 may be configured to rotate the offset bracket 200, thereby loosening or tightening the assembly 100 relative to the conduit. The handhole cover 300 may present a flat exterior surface that may cover the handhole opening when installed. The locking interface may be substantially flush with or slightly recessed from the cover surface. The cover 300 may be sized and shaped to match standard handhole configurations used in lighting pole installations. The locking pole light handhole cover assembly 100 may provide several operational advantages. The system may prevent theft of electrical wires by securing the handhole cover from inside the pole conduit where unauthorized persons may not have access. The key-operated mechanism may allow authorized maintenance personnel to access electrical connections when needed while maintaining security when access may not be required.

### Installation Methods

Installation of the assembly 100 may be accomplished by positioning the offset bracket 200 inside the pole conduit, aligning the handhole cover 300 over the handhole opening, and inserting the threaded rod 404 through both components. The key 410 may then be used to tighten the assembly until the offset bracket 200 may contact the interior pole surface with sufficient force to secure the cover. The adjustable positioning capability of the offset bracket 200 along the threaded rod 404 may accommodate different pole wall thicknesses and handhole configurations. This adjustability may make the system adaptable to various lighting pole designs without requiring custom modifications. The materials used in construction of the assembly 100 may be selected for durability in outdoor environments. The components may be resistant to corrosion, weather exposure, and mechanical stress that may be encountered in typical lighting pole installations.

Various modifications and alternative configurations may be possible within the scope of the disclosed subject matter. The dimensions, materials, and specific mechanical arrangements may be varied to suit particular applications or installation requirements. The locking mechanism may incorporate different key types or security levels as may be appropriate for specific security needs. The threaded rod lock 400 may be replaceable or serviceable to maintain long-term functionality. The threading engagement between the rod 404 and offset bracket 200 may be configured to provide smooth operation over extended periods of use while maintaining secure holding capability.

Additional security features may be incorporated into various embodiments, such as tamper-evident indicators, multiple locking points, or integration with electronic monitoring systems. The basic mechanical principles of internal anchoring through threaded rod advancement may be maintained while adding supplementary security measures. The system may be scaled for different sizes of lighting poles and handhole openings. Larger installations may use proportionally sized components while maintaining the same operational principles. Smaller installations may use compact versions of the components while preserving the security functionality.

Manufacturing of the assembly components may utilize standard metalworking techniques and readily available materials. The threaded rod lock 400 may be sourced from commercial suppliers or manufactured to specific requirements. The offset bracket 200 and handhole cover 300 may be fabricated using conventional forming and machining processes. Quality control measures may ensure proper fit and function of the threaded engagement between components. Thread specifications may be maintained within appropriate tolerances to provide smooth operation and secure holding capability. Surface treatments may be applied to enhance corrosion resistance and appearance.

The disclosed locking pole light handhole cover assembly may represent an improvement over conventional handhole covers by providing effective theft prevention while maintaining accessibility for authorized maintenance. The internal anchoring approach may offer advantages over external fastening methods that may be more easily defeated by unauthorized persons.

What is claimed is:

1. A locking pole light handhole cover assembly comprising:
a pole light handhole cover comprising a flat plate with a center hole;
a cover offset bracket comprising a center hole with female threads, wherein the cover offset bracket may be positioned inside a pole conduit;
a threaded rod lock comprising a threaded rod with male threads and a key-operated mechanism, wherein the threaded rod may pass through the center holes of the pole light handhole cover and the cover offset bracket; and
wherein the male threads of the threaded rod may engage with the female threads of the cover offset bracket to secure the assembly through internal anchoring within the pole conduit.

2. The locking pole light handhole cover assembly of claim 1, wherein the key-operated mechanism may comprise a key that may be inserted into the threaded rod lock to control rotational movement of the threaded rod.

3. The locking pole light handhole cover assembly of claim 2, wherein rotation of the key in a clockwise direction may advance the threaded rod to tighten the assembly, and rotation of the key in a counterclockwise direction may retract the threaded rod to loosen the assembly.

4. The locking pole light handhole cover assembly of claim 1, wherein the cover offset bracket may be configured to contact an interior wall of the pole conduit when the threaded rod may be advanced.

5. The locking pole light handhole cover assembly of claim 4, wherein contact between the cover offset bracket and the interior wall may create a clamping force that may secure the handhole cover assembly to the pole conduit.

6. The locking pole light handhole cover assembly of claim 1, further comprising an anchor nut configured to secure the pole light handhole cover to the threaded rod lock.

7. The locking pole light handhole cover assembly of claim 1, wherein the pole light handhole cover may be sized to cover square or oblong handhole openings.

8. The locking pole light handhole cover assembly of claim 1, wherein the position of the cover offset bracket relative to the threaded rod may be adjustable to accommodate different pole configurations.

9. The locking pole light handhole cover assembly of claim 1, wherein the threaded rod lock may comprise a commercial locking mechanism.

10. The locking pole light handhole cover assembly of claim 1, wherein the assembly may be configured to prevent unauthorized access to electrical wires within the pole conduit.

11. A method for securing a handhole cover on a lighting pole comprising:
positioning a cover offset bracket inside a pole conduit, wherein the cover offset bracket may comprise a center hole with female threads;
aligning a pole light handhole cover over a handhole opening, wherein the pole light handhole cover may comprise a flat plate with a center hole;
inserting a threaded rod through the center holes of the pole light handhole cover and the cover offset bracket, wherein the threaded rod may comprise male threads;
engaging the male threads of the threaded rod with the female threads of the cover offset bracket; and
rotating the threaded rod using a key-operated mechanism to advance the threaded rod and secure the cover offset bracket against an interior wall of the pole conduit.

12. The method of claim 11, wherein rotating the threaded rod may comprise inserting a key into a threaded rod lock and turning the key in a clockwise direction.

13. The method of claim 11, wherein securing the cover offset bracket against the interior wall may create a clamping force that may prevent unauthorized removal of the handhole cover.

14. The method of claim 11, further comprising adjusting a position of the cover offset bracket along the threaded rod to accommodate a wall thickness of the pole conduit.

15. The method of claim 11, further comprising securing an anchor nut to attach the pole light handhole cover to the threaded rod.

16. The method of claim 11, wherein the method may provide theft prevention for electrical wires within the pole conduit.

17. The method of claim 11, further comprising removing the key after securing the assembly to prevent unauthorized access.

18. A security system for lighting pole infrastructure comprising:
a plurality of lighting poles, each comprising a conduit containing electrical wires and a handhole opening for maintenance access;
a plurality of locking handhole cover assemblies, each comprising:
a pole light handhole cover configured to cover the handhole opening;
a cover offset bracket positioned inside the conduit and comprising female threads;
a threaded rod lock comprising a threaded rod with male threads that may engage the female threads of the cover offset bracket; and
a key-operated mechanism that may control advancement and retraction of the threaded rod to secure or release the cover offset bracket from an interior wall of the conduit.

19. The security system of claim 18, wherein each locking handhole cover assembly may prevent unauthorized access to the electrical wires while allowing authorized maintenance through key operation.

20. The security system of claim 18, wherein the key-operated mechanism may comprise a removable key that may be distributed to authorized maintenance personnel.
